(19) United States
(12) Patent Application Publication
(10) Pub. No.: US 2007/0037022 A1
(43) Pub. Date: Feb. 15, 2007

(54) Startup method of fuel cell system

(75) Inventors: Soonho Kim, Seoul (KR); Hyun-chul Lee, Yongsin-si (KR); Doohwan Lee, Daejeon-si (KR); Dong-woo Lee, Seoul (KR); Tae-sang Park, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd, Suwon-si (KR)

(21) Appl. No.: 11/503,149

(22) Filed: Aug. 14, 2006

(30) Foreign Application Priority Data
Aug. 13, 2005 (KR) 2005-74570

(51) Int. Cl. H01M 8/04

(52) U.S. Cl. 429/13; 429/26

(57) ABSTRACT

In a startup method for fuel cell systems, and more particularly, a startup method which makes the fuel cell systems rapidly reach a steady state operation by significantly decreasing the time taken to increase the temperature of the shift reactor catalyst, gas discharged from a burner that heats a reformer is supplied into the shift reactor. In the startup method of the fuel cell system, the fuel cell systems rapidly reach a steady state operation thereby significantly improving the utility of the fuel cell system. In addition, the fuel cell system is economical in that gases discharged from burners included in the fuel cell system and waste heat are used.

### CROSS-REFERENCE TO RELATED APPLICATION

This application claims the benefit of Korean Patent Application No. 2005-74570, filed on Aug. 13, 2005, in the Korean Intellectual Property Office, the disclosure of which is incorporated herein in its entirety by reference.

### BACKGROUND OF THE INVENTION

1. Field of the Invention

Aspects of the present invention relate to a startup method for fuel cell systems, and more particularly, to an economical startup method capable of making a fuel cell system rapidly reach a steady state operation using a simple device.

2. Description of the Related Art

A fuel cell is a type of energy generating device in which energy from a chemical reaction between hydrogen and oxygen is directly converted to electrical energy, wherein the hydrogen is contained in a hydrocarbon-based material such as methanol, ethanol or natural gas.

Such fuel cell systems include fuel cell stacks and fuel processors (FP) as main elements and further include fuel tanks, fuel pumps, etc., as sub-elements. The fuel cell stack forms the main body of the fuel cell and is formed of a structure having a plurality of layers of unit cells, which include membrane electrode assemblies (MEA) and separators.

The fuel stored in the fuel tank is supplied into the FP by the fuel pump. The FP reforms and purifies the fuel to generate hydrogen, and supplies the generated hydrogen into the fuel cell stack. In the fuel cell stack, the supplied hydrogen electrochemically reacts with oxygen to generate electrical energy.

In the FP, a hydrocarbon is reformed using a catalyst in a reforming process. If the hydrocarbon includes a sulfur compound, the sulfur compound must be removed before the hydrocarbon is supplied into the FP, since sulfur compounds can easily poison the catalyst. Therefore, a desulfurization process is performed prior to the reforming process.

When the hydrocarbon is reformed, not only hydrogen but also carbon dioxide and small amount of carbon monoxide are generated. Because of the presence of carbon monoxide, which can poison catalysts that are used for electrodes of the fuel cell stack, the reformed fuel should not be directly supplied into the fuel cell stack. Instead, a shift process should be performed to remove carbon monoxide. The concentration of carbon monoxide should be reduced to less than 5000 ppm.

Reactions such as a shift reaction, a methanation reaction and a PROX reaction described in Reaction Schemes 1 through 3 below are conventionally used to remove carbon monoxide (CO).
CO+H₂O→CO₂+H₂ Reaction Scheme 1
CO+3H₂→CH₄+H₂O Reaction 2
CO+½O₂→CO₂ Reaction Scheme 3

In order to lower the carbon monoxide concentration to less than 5000 ppm, the temperature of the shift reactor is required to be 150° C. or higher. However, preheating a shift reactor to the required temperature takes about one hour. This preheating time of one hour required before electrical energy can be generated is a disadvantage of the conventional startup method of fuel cells, and thus there is a need to shorten the required preheating time.

In a conventional startup method of a fuel processor, high temperature nitrogen gas is passed through the shift reactor to increase the temperature of the shift reactor. However, using nitrogen gas is economically disadvantageous, since nitrogen gas and additional energy for heating the nitrogen gas are required. Also, the temperature of the shift reactor cannot be rapidly increased by the conventional startup method.

Therefore, there is a need for a startup method that is capable of quickly increasing the temperature of a shift reactor catalyst with a simple device.

### SUMMARY OF THE INVENTION

Aspects of the present invention provide an economical startup method capable of making fuel cell systems rapidly reach a steady state operation using a simple device.

According to an aspect of the present invention, there is provided a startup method of a fuel cell system including heating a reformer by burning fuel in a first burner of the reformer and passing a gas discharged from the first burner through a shift reactor.

Additionally, the startup method for fuel cell systems may include heating the reformer by burning fuel in the first burner of the reformer, combining gas discharged from the first burner with water or water vapor, supplying the combined gas and water or water vapor into the reformer, and passing the discharge of the reformer through the shift reactor.

Alternatively, the startup method of fuel cell systems may include heating the reformer by burning fuel in the first burner of the reformer, supplying water or water vapor into the reformer, and passing the discharge from the reformer through the shift reactor.

The startup method of fuel cell systems may include heating the reformer by burning fuel in the first burner of the reformer, supplying fuel and water or water vapor into the reformer, supplying a mixture of the reformed fuel and water vapor into the shift reactor, and discharging a mixture from the shift reactor.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A is a conceptual diagram illustrating a startup method of a conventional fuel cell system;

FIG. 1B a conceptual diagram illustrating a startup method of a fuel cell system according to an embodiment of the present invention;

FIGS. 2A and 2B are conceptual diagrams illustrating an operation of a startup of fuel cell systems according to additional embodiments of the present invention;

FIGS. 3A and 3B are conceptual diagrams illustrating an operation of a startup of fuel cell systems according to additional embodiments of the present invention;

FIG. 4 is a conceptual diagrams illustrating a steady state operation of a fuel cell system; and

FIG. 5 is a conceptual diagram illustrating an operation of a startup of a fuel cell system.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

A startup method of fuel cell systems according to an embodiment of the present invention includes heating a reformer by burning a fuel in a first burner of the reformer, and passing a gas discharged from the first burner (hereinafter referred to as “the first discharge gas”) through a shift reactor.

Since the first discharge gas is the product of the combustion of the fuel, carbon dioxide and water vapor, which are relatively stable in chemical reactions, constitute most of the first discharge gas. Thus, the first discharge gas does not poison the catalysts inside the shift reactor even when the first discharge gas passes through the shift reactor. The high temperature of the first discharge gas can rapidly heat the shift reactor catalysts by direct contact.

The stoichiometric mole ratio of oxygen to hydrocarbon in the first burner may be less than 1:1. The stoichiometric mole ratio indicates a mole ratio divided by a stoichiometric coefficient. When the first discharge gas includes unreacted oxygen molecules that were not used in the combustion reaction of the hydrocarbon fuel, the oxygen molecules oxidize the shift reactor catalysts, which is undesirable. Particularly, the stoichiometric mole ratio of oxygen to hydrocarbon may be in the range of 1:1 to 1:2. When the stoichiometric mole ratio of oxygen to hydrocarbon is greater than 1:1, unreacted oxygen may oxidize the shift reactor catalysts. When the stoichiometric mole ratio of oxygen to hydrocarbon is less than 1:2, the amount of oxygen may be too small to trigger a combustion reaction.

The temperature of the first discharge gas flowing into the shift reactor may be in a range of 150° C. to 500° C. When the temperature of the first discharge gas is less than 150° C., the temperature of the shift reactor catalyst may increase too slowly, and when the temperature of the first discharge gas is greater than 500° C., the shift reactor catalyst can be damaged.

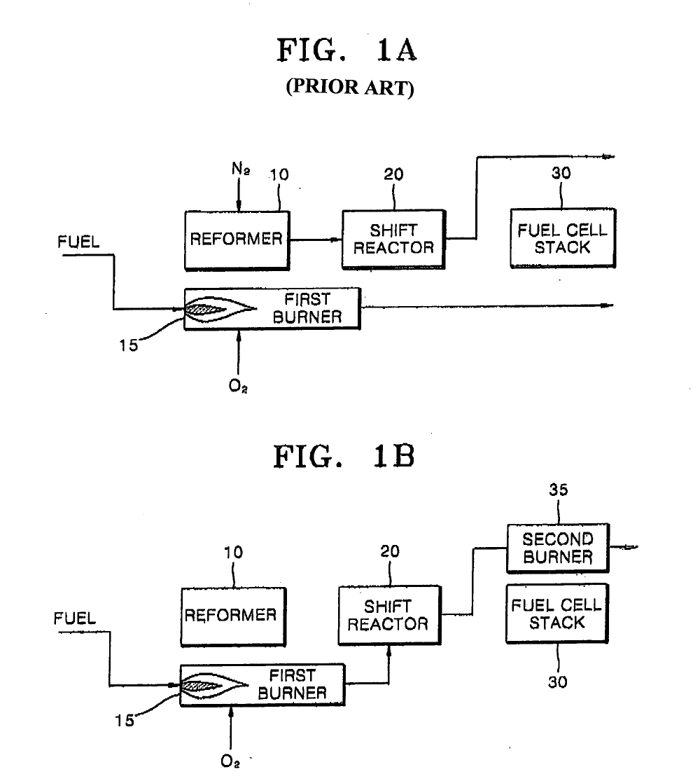

The startup method according to this embodiment of the present invention is described below as compared with a conventional startup method and with reference to FIGS. 1A and 1B. FIG. 1A is a conceptual diagram illustrating a conventional startup method of a fuel cell system. Referring to FIG. 1A, in the conventional method, the reformer 10 is heated by burning the fuel in the first burner 15. Nitrogen gas is passed through the reformer 10, and then, the heated nitrogen gas in the reformer 10 is passed through the shift reactor 20 to increase the temperature of the shift reactor catalyst.

FIG. 1B is a conceptual diagram of the startup method of a fuel cell system according to an embodiment of the present invention. Referring to FIG. 1B, in the startup method of the fuel cell system according to this embodiment of the present invention, the shift reactor 20 is heated by directly passing the gas discharged from the first burner 15 through the shift reactor 20 after the fuel is burned in the first burner 15. That is, the temperature of the shift reactor 20 can be rapidly increased by directly using the heat of the gas discharged from the first burner 15.

The gas discharged from the shift reactor 20 may be directly exhausted out of the fuel cell, but it is more environmentally friendly if the gas is burned in a second burner 35 and then discharged. In that case, excessive oxygen is preferably supplied into the second burner 35 to eliminate carbon monoxide or unreacted hydrocarbon through complete combustion. That is, the stoichiometric mole ratio of oxygen to hydrocarbon may be greater than 1:1. In addition, the heat generated by the second burner 35 can be used to heat a fuel cell stack 30, and particularly, a cathode of the fuel cell stack 30. The fuel cell stack 30 can be heated by passing gas discharged from the second burner 35 through the fuel cell stack 30.

Meanwhile, the temperature of the shift reactor 20, after being heated according to the start-up method shown in FIG. 1B, is 150° C. or higher, which is sufficient to decrease the amount of carbon monoxide in the fuel to a level suitable for supplying the fuel into the fuel cell stack 30.

When the first discharge gas passes through the shift reactor 20, the temperature of the shift reactor catalyst rapidly increases. However, the reformer 10 may reach its maximum allowable temperature before the temperature of the shift reactor catalyst reaches 150° C.

To prevent such overheating of the reformer 10, a procedure that allows the temperature of the shift reactor catalyst to continuously increase without further increasing the temperature of the reformer 10 may be required, as described below.

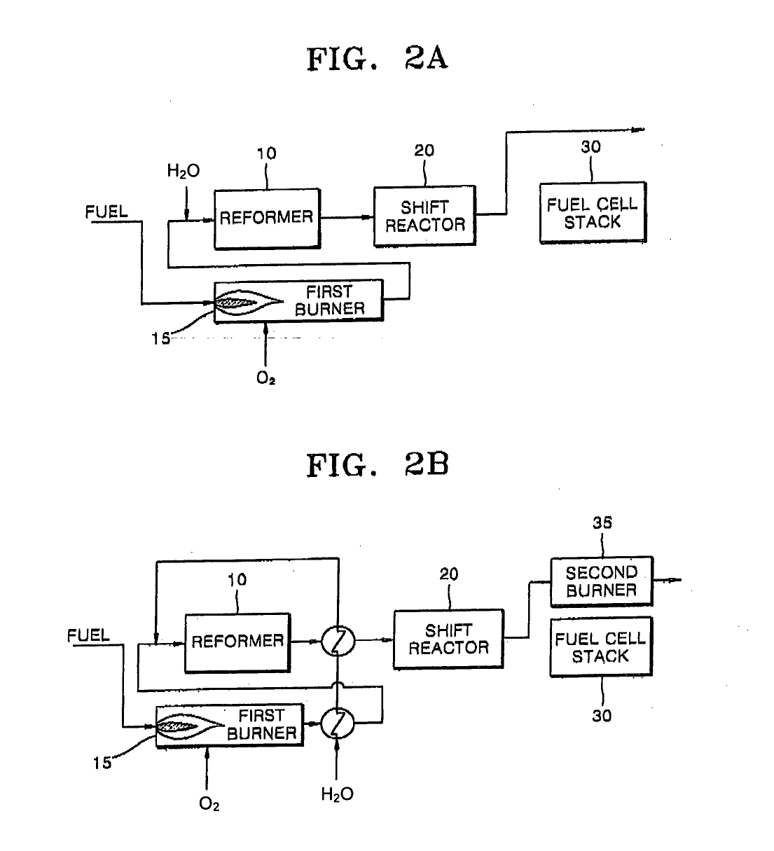

FIGS. 2A and 2B are conceptual diagrams illustrating operations of a startup of fuel cell systems according to additional embodiments of the present invention that include an additional procedure of supplying water or water vapor to the reformer 10.

Referring to FIG. 2A, fuel is burned in the first burner 15, and the discharge gas from the first burner 15 is supplied into the reformer 10, along with the water or water vapor. Then, the gas heated in and discharged from the reformer 10 is supplied into the shift reactor 20 to increase the temperature of the shift reactor catalyst.

Referring to FIG. 2B, the fuel is burned in the first burner 15, and the discharge gas and water or water vapor may be selectively supplied into the reformer 10. Discharge gas leaving the reformer 10 can be heat exchanged before being supplied to the shift reactor 20.

In these embodiments, the water or water vapor is supplied to prevent the reformer 10 from overheating and to prevent coke deposition on the reformer 10 and/or on the shift reactor catalyst, the coke being from carbon monoxide or unreacted hydrocarbon contained in the first discharge gas.

In these embodiments as well, the stoichiometric mole ratio of oxygen to hydrocarbon can be less than 1:1. Particularly, the stoichiometric mole ratio of oxygen to hydrocarbon may be in the range of 1:1 to 1:2. When the stoichiometric mole ratio of oxygen to hydrocarbon is greater than 1:1, unreacted oxygen may oxidize the shift reactor catalysts. When the stoichiometric mole ratio of oxygen to hydrocarbon is less than 1:2, the amount of oxygen may be too small to trigger a combustion reaction.

The water supplied into the reformer 10 can rapidly evaporate to become vapor due to the high temperature of the reformer 10; however, the vapor can instantly be condensed locally, and thus supplying water vapor instead of water may be preferable. If the water supplied to the reformer 10 is in the form of water vapor, the water vapor can be generated by evaporating water using an external heat source. However, using the heat of the first discharge gas and/or the discharge gas of the reformer 10 to produce the water vapor is more economical.

The gas discharged from the shift reactor 20 may be fully discarded out of the fuel cell. However, burning the gas again in the second burner 35 and then discarding the products of the second combustion out of the fuel cell, as shown in FIG. 2B is more environmentally friendly. An excessive amount of oxygen can be supplied into the second burner 35 to burn the gas completely and to remove carbon monoxide or unreacted hydrocarbon. That is, a stoichiometric mole ratio of oxygen to hydrocarbon can be greater than 1:1. Additionally, the heat generated by the second burner 35 can be used to heat the fuel cell stack 30, and particularly, the cathode of the fuel cell stack 30. For example, the discharge gas from the second burner 35 can be passed through to heat the fuel cell stack 30.

Water or water vapor supply can be initiated when the temperature of the reformer 10 reaches 100° C. or greater. For example, water or water vapor may be supplied when the temperature of the reformer 10 reaches 400° C.

The water vapor that passes through the shift reactor 20 can be fully exhausted out of the fuel cell with or without the first discharge gas.

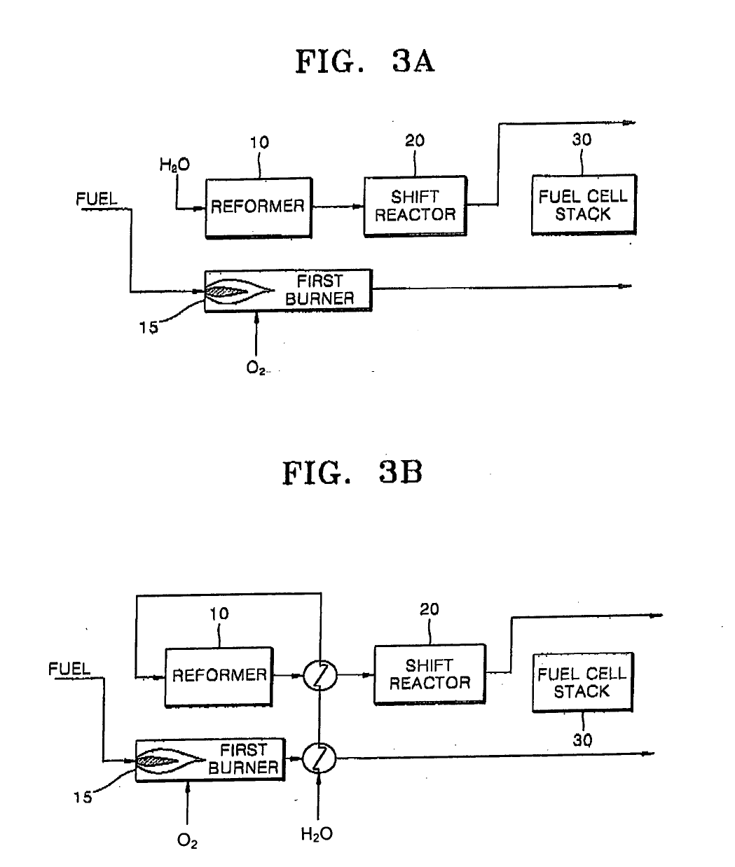

FIGS. 3A, 3B and 3C are conceptual diagrams illustrating an operation of a startup of fuel cell systems according to additional embodiments of the present invention.

Referring to FIG. 3A, first, the fuel is burned in the first burner 15, and water or water vapor is supplied into the reformer 10. The water or water vapor is further heated and rapidly increases the temperature of the catalyst of the shift reactor 20 and then is discharged with the gas discharged form the first burner 15.

In these embodiments as well, the stoichiometric mole ratio of oxygen to hydrocarbon can be less than 1:1. Particularly, the stoichiometric mole ratio of oxygen to hydrocarbon may be in the range of 1:1 to 1:2. When the stoichiometric mole ratio of oxygen to hydrocarbon is greater than 1:1, unreacted oxygen may oxidize the shift reactor catalysts. When the stoichiometric mole ratio of oxygen to hydrocarbon is less than 1:2, the amount of oxygen may be too small to trigger a combustion reaction. It is possible for the stoichiometric mole ratio of oxygen to hydrocarbon to be greater than 1:1. However, in this case, passing the first discharge gas through the shift reactor 20 is not desirable because there is a possibility of excessive oxygen being present in the first discharge gas as a result of a complete combustion of hydrocarbon. Therefore, the first discharge gas can be fully exhausted from the fuel cell with or without water vapor from the shift reactor 20.

The discharged gas from the first burner 15 can be passed through the shift reactor 20 as shown in FIG. 3C to rapidly increase the temperature of the shift reactor 20. The gas that is passed through the shift reactor 20 may contain unreacted hydrocarbon and carbon monoxide, etc., which may be completely burned in the second burner 35. Additionally, the heat generated by the second burner 35 can be used to heat the fuel cell stack 30, and particularly, the cathode of the fuel cell stack 30. The discharged gas from the second burner 35 can be passed through the fuel cell stack 30 to heat the fuel cell stack 30.

The water vapor can be generated by evaporating water using an external heat source. However, using the heat of the first discharge gas and/or the reformer 10, as illustrated in FIG. 3B, is more economical.

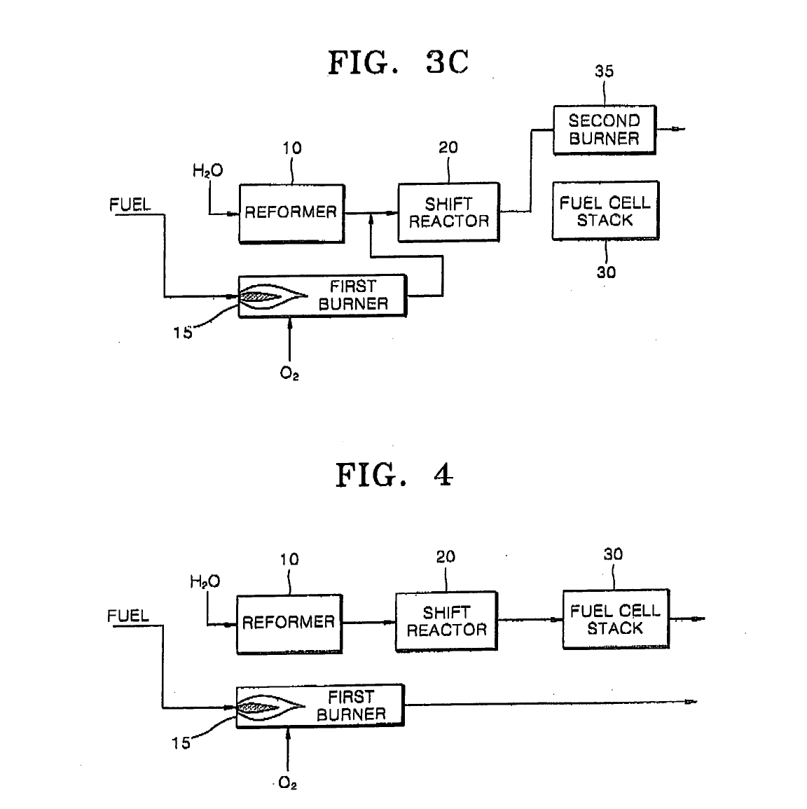

According to these procedures, when the temperature reaches 150° C., a steady state operation is performed by supplying the fuel into the reformer 10. A method of the steady state operation according to an additional embodiment of the present invention is described with reference to FIG. 4.

FIG. 4 is a conceptual diagram illustrating a steady state operation of a fuel cell system. Referring to FIG. 4, thermal energy that is necessary for a reforming reaction in the reformer 10 is supplied by burning the fuel in the first burner 15. Fuel and water vapor are supplied into the reformer 10, and the reforming reaction occurs. Carbon monoxide contained in the reformed fuel (reformate) is removed by supplying the reformed fuel into the shift reactor 20, and then, the resultant fuel is supplied into the fuel cell stack 30.

Meanwhile, even when the temperature of the shift reactor 20 reaches 150° C., the concentration of carbon monoxide may be greater than 5000 ppm on occasion. This is a temporary phenomenon due to the separation of the combustion gas system and fuel cell gas system and the steady state operation. However, this phenomenon should be prevented in spite of its momentary nature, because regeneration of the shift reactor catalyst is rarely possible once the carbon monoxide poisons the catalyst.

To prevent such a phenomenon, the reformer 10 is heated by burning the fuel in the first burner 15 of the reformer 10, the fuel and water or water vapor are supplied into the reformer 10, a mixture of the reformed fuel from the reformer 10 and water vapor are supplied into the shift reactor 20, and the mixture from the shift reactor 20 is discharged.

The gas discharged from the shift reactor 20 may be fully discarded out of the fuel cell. However, burning the gas again in the second burner 35 and then fully discharging the combusted gas out of the fuel cell is more environmentally friendly. Here, an excessive amount of oxygen can be supplied into the second burner 35 to burn the gas completely and to remove carbon monoxide or unreacted hydrocarbon. That is, the stoichiometric mole ratio of oxygen to hydrocarbon may be greater than 1:1. Additionally, the heat generated by the second burner 35 can be used to heat the fuel cell stack 30, and particularly, the cathode of the fuel cell stack 30. The discharge gas from the second burner 35 can be passed through to heat the fuel cell stack 30.

Then, the discharged gas from the first burner, after being burned in the first burner 15, is fully discarded out of the fuel cell. Therefore, an excessive amount of oxygen may be supplied into the first burner 15 to prevent the discharge of carbon monoxide or unreacted hydrocarbon.

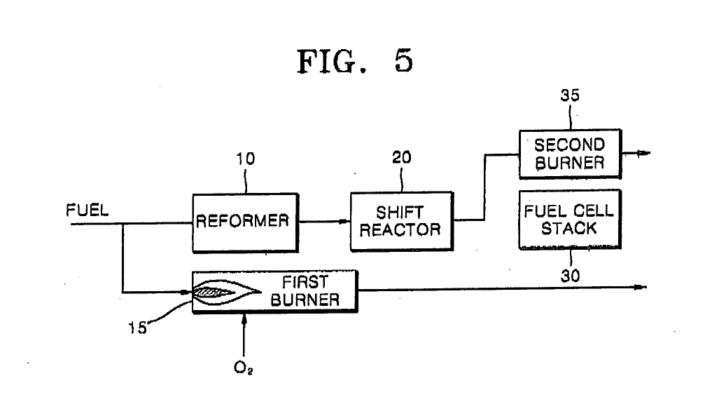

FIG. 5 is a conceptual diagram illustrating an operation of a startup method of a fuel cell system.

Referring to FIG. 5, first, the fuel is supplied into the first burner 15 and the reformer 10. The fuel supplied into the first burner 15 reacts with an excessive amount of oxygen and converts into water and carbon dioxide to be discharged. The fuel supplied into the reformer 10 with water or water vapor undergoes the reforming reaction to produce a hydrogen rich gas, which is supplied into the shift reactor 20. Although carbon monoxide is removed in the shift reactor 20, the concentration of carbon monoxide may exceed 5000 ppm due to variation of the feedstock and the combustion residue. Thus, gas discharged from the shift reactor 20 may be discharged to the outside until the entire fuel processor operates stably.

The water vapor can be generated by evaporating water using an external heat source; however, using the heat of the first discharge gas and/or the reformer 10 to generate water vapor is more economical.

In the startup method of the fuel cell system described above, the fuel can be passed through a desulfurizer before being supplied into the reformer or the first burner.

According to the startup method of the fuel cell system according to aspects of the present invention, the fuel cell system rapidly reaches a steady state operation using a simple device, thereby significantly improving the utility of the fuel cell system. In addition, the fuel cell system is economical in that gases discharged from burners included in the fuel cell system and waste heat are used to heat the shift reactor.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A startup method of a fuel cell system comprising:
heating a reformer by burning fuel in a first burner of the reformer; and
passing a gas discharged from the first burner through a shift reactor.

2. The startup method of claim 1, wherein a stoichiometric mole ratio of oxygen to hydrocarbon in the first burner is less than 1:1.

3. The startup method of claim 1, further comprising burning the gas that has passed through the shift reactor in a second burner, wherein a stoichiometric mole ratio of oxygen to hydrocarbon in the second burner is greater than 1:1.

4. The startup method of claim 3, further comprising supplying heat generated by the second burner to a cathode of a fuel cell stack.

5. The startup method of claim 1, wherein the gas discharged from the first burner and passed through the shift reactor has a temperature in a range of 150° C. to 500° C.

6. The startup method of claim 1, further including desulfurizing the fuel before burning the fuel in the first burner.

7. A startup method of a fuel cell system, comprising:
heating a reformer by burning fuel in a first burner of the reformer;
combining a gas discharged from the first burner with water or water vapor, supplying the gas combined with water or water vapor into the reformer; and
passing a gas discharged from the reformer through a shift reactor.

8. The startup method of claim 7, wherein a stoichiometric mole ratio of oxygen to hydrocarbon in the first burner is less than 1:1.

9. The startup method of claim 7, wherein the water vapor that is combined with the gas discharged from the first burner is generated using heat of the gas discharged from the first burner or heat of the gas discharged from the reformer.

10. The startup method of claim 7, further comprising burning the gas discharged from the shift reactor in a second burner, wherein a stoichiometric mole ratio of oxygen to hydrocarbon in the second burner is greater than 1:1.

11. The startup method of claim 10, further comprising supplying heat generated by the second burner to a cathode of a fuel cell stack.

12. The startup method of claim 7, further including desulfurizing the fuel before burning the fuel in the first burner.

13. A startup method of a fuel cell system comprising:
heating a reformer by burning fuel in the first burner of the reformer;
supplying water or water vapor into the reformer, wherein the water or water vapor is discharged from the reformer in the form of water vapor; and
passing the water vapor discharged from the reformer through the shift reactor.

14. The startup method of claim 13, wherein a stoichiometric mole ratio of oxygen to hydrocarbon in the first burner is less than 1:1.

15. The startup method of claim 14, further comprising passing a gas discharged from the first burner through the shift reactor.

16. The startup method of claim 15, further comprising burning a gas discharged from the shift reactor in a second burner, wherein a stoichiometric mole ratio of oxygen to hydrocarbon in the second burner is greater than 1:1.

17. The startup method of claim 16, further comprising supplying heat generated by the second burner to a cathode of a fuel cell stack.

18. The startup method of claim 13, wherein the water vapor that is supplied to the reformer is generated using the heat of the gas discharged from the first burner or the water vapor discharged from the reformer.

19. The startup method of claim 13, further including desulfurizing the fuel before burning the fuel in the first burner.

20. The startup method of claim 1, further comprising:
supplying fuel and water or water vapor into the reformer;
supplying a mixture of the reformed fuel and water vapor into the shift reactor; and
discharging the mixture from the shift reactor.

21. The startup method of claim 20, further including desulfurizing the fuel before supplying the fuel to the reformer.

22. The startup method of claim 20, further comprising burning the mixture discharged from the shift reactor in a second burner, wherein a stoichiometric mole ratio of oxygen to hydrocarbon in the second burner is greater than 1:1.

23. The startup method of claim 22, further comprising supplying heat generated by the second burner to the cathode of the fuel cell stack.

24. The startup method of claim 7, further comprising:
supplying fuel and water or water vapor into the reformer;
supplying a mixture of the reformed fuel and water vapor into the shift reactor; and
discharging the mixture from the shift reactor.

25. The startup method of claim 24, further comprising burning the mixture discharged from the shift reactor in a second burner, wherein a stoichiometric mole ratio of oxygen to hydrocarbon in the second burner is greater than 1:1.

26. The startup method of claim 13 further comprising:
supplying fuel and water or water vapor into the reformer;
supplying a mixture of the reformed fuel and water vapor into the shift reactor; and
discharging the mixture from the shift reactor.

27. The startup method of claim 20, further comprising burning the mixture discharged from the shift reactor in a second burner, wherein a stoichiometric mole ratio of oxygen to hydrocarbon in the second burner is greater than 1:1.
